(19) United States
(12) Patent Application Publication
(10) Pub. No.: US 2006/0086542 A1
(43) Pub. Date: Apr. 27, 2006

(54) Control mechanism of the steering differential device for an electric vehicle

(76) Inventor: Yung Cheng Chen, Tao Yuan City (TW)

Correspondence Address: John S. Egbert;Harrison & Egbert, 7th Floor, 412 Main Street, Houston, TX, 77002, US

(21) Appl. No.: 11/035,446

(22) Filed: Jan. 14, 2005

(30) Foreign Application Priority Data
Oct. 26, 2004 (TW) 093216988

(51) Int. Cl. B62D 11/24

(52) U.S. Cl. 180/6.24

(57) ABSTRACT

The control mechanism for a steering differential device of an electric vehicle includes a touch sensor switch assembled on the fixed shaft sleeve of the head tube on the electric vehicle, with a feeler in a downward configuration state. The electric circuit of the sensor switch is connected with the controller that controls two rear wheels of the electric vehicle. A guiding base, which is set on the top of the wheel carrier lying at the bottom of the head tube and is exactly aligned to the place beneath the sensor switch. Its middle part forms a flat surface, and its left and right ends form the downward bevels, respectively. The sensor foot can exactly touch against the flat surface of the guiding base and the circuit then appears to be closed due to the pressure. The feeler can be aligned to one downward bevel of the guiding base.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an electric vehicle, and more particularly to an electric vehicle having a control mechanism comprised of a steering differential device on the left and right rear wheels.

### BACKGROUND OF THE INVENTION

It has been noted that conventional electric vehicles can be roughly classified into the types of two-wheel and three-wheel. What the present invention tends to improve concerns the three-wheel electric vehicles. Because the left and right rear wheels of an electric vehicle require different gyration radiuses when the electric vehicle turns, in between them there should be assembled with a differential device to form rotational speed difference, such that the vehicle body can turn smoothly and safely. Specifically, the actuation style of the operation of the differential device is different when the vehicle body moves along a straight line or turns around, which is achieved by the reliance on the assembly of a switch control mechanism. However, nowadays switch control mechanisms have some general problems like complicated structures, inconveniences in assembly, replacement and repair. These problems cause the increase in manufacture and assemble costs, which does not satisfy the economic benefit. It is thus necessary to further improve this structural part and overcome the problems associated with the part.

As a result, aiming at the problems existing in the conventional structures known from the above discussion, how to develop a type of new structure that is of more practicality, indeed becomes the aim and direction that must be further studied and breached by the concerned practitioners with further efforts.

In the light of this, the inventor, based on the experiences of designing and developing related products for many years, aimed at the above objective, and after detailed design and cautious evaluation, ultimately obtained an invention of real practicability.

### BRIEF SUMMARY OF THE INVENTION

The facts of improving functionality by the present invention follow.

The present invention provides a type of innovative mechanism to control the turning speed differential of electric vehicles, with the combination of a touch sensor switch and a guiding base, and is really the first seen design in this industry that meets the novelty requirement for new patents.

Through such special structural design, the touch sensor switch is easily available and low in production cost because it is a type of standard switch product. And the guiding base is simple for mass production. Additionally, these two parts are installed on the head tube, which is not obstructed, so they are rather convenient to install or repair in the future. Then this design can arouse economic effects in that it reduces the manufacture and installation cost because of the simple structure and easy installation and replacement.

The above is the detailed description of the technical characteristics of this invention based on the instance that is implemented quite well. However, experts familiar with this technique are allowed to change and modify this invention as long as they do not depart from the spirit and principle of this invention. Any change and modification may still be confined to the following scope defined by the present patent.

### BRIEF DESCRIPTION OF THE SEVERAL VIEWS OF THE DRAWINGS

FIG. 1 shows a perspective view of the control mechanism of the steering differential device.

FIG. 2 shows a front elevation view of the control mechanism of the steering differential device.

FIG. 3 shows a side elevation view of the connection between the sensor switch and the controller of the electric vehicle.

FIG. 4 shows a top plan view of the wheel carrier in leveled position.

FIG. 5 shows an elevation view of the feeler of the sensor switch in pressed position according to FIG. 4.

FIG. 6 shows another top plan view of the wheel carrier tuning to the right.

FIG. 7 shows another elevation view of the feeler of the sensor switch in pressed position according to FIG. 6.

FIG. 8 shows still another top plan view of the wheel carrier tuning to the left.

FIG. 9 shows still another elevation view of the feeler of the sensor switch in pressed position according to FIG. 8.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

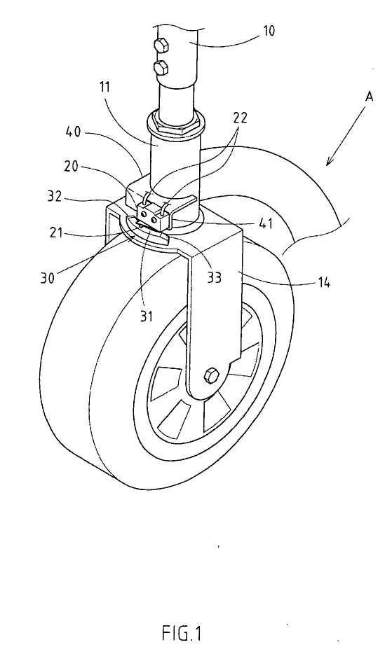

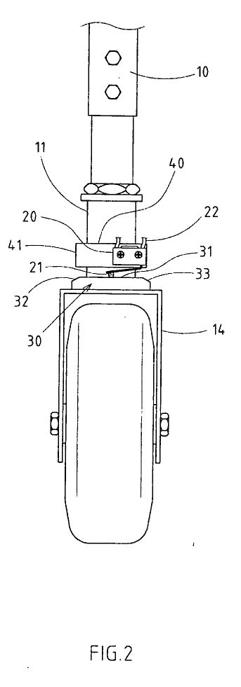

As shown in FIGS. 1-3, there is an the control mechanism of the steering differential device for an electric vehicle embodied in the present invention.

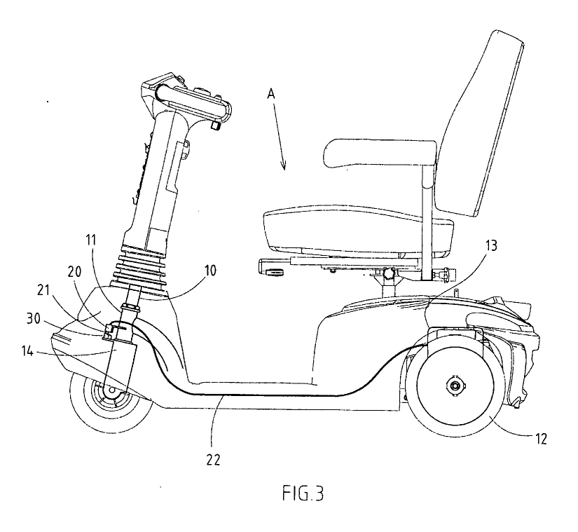

The present invention has a touch sensor switch 20 assembled on one side of the fixed shaft sleeve 11 of the head tube 10 on the electric vehicle A (as shown in FIG. 3), which feeler 21 is in the downward configuration state. The electric circuit 22 of the sensor switch 20 is connected with the controller 13 which controls the two rear wheels 12 of the electric vehicle A, and therein the controller is an existing structure.

There is also a guiding base 30, which is set on the top of the wheel carrier 14 lying at the bottom of the head tube 10, and is exactly aligned to the place beneath the aforementioned sensor switch 20. Its middle part forms a flat surface 31, and its left and right ends form the downward bevels 32 33, respectively.

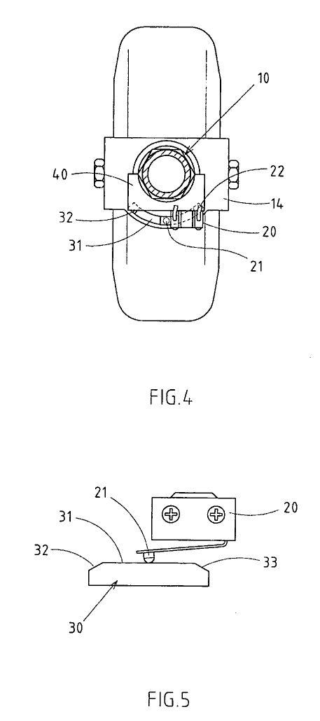

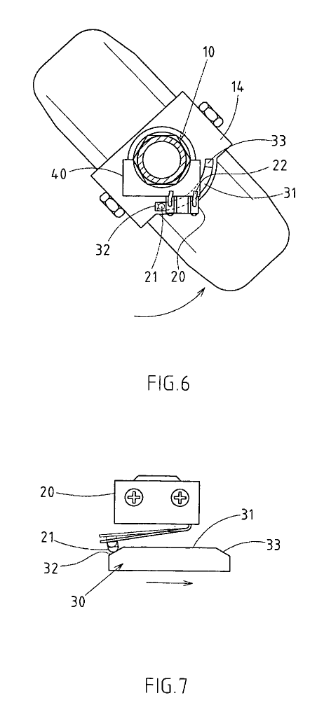

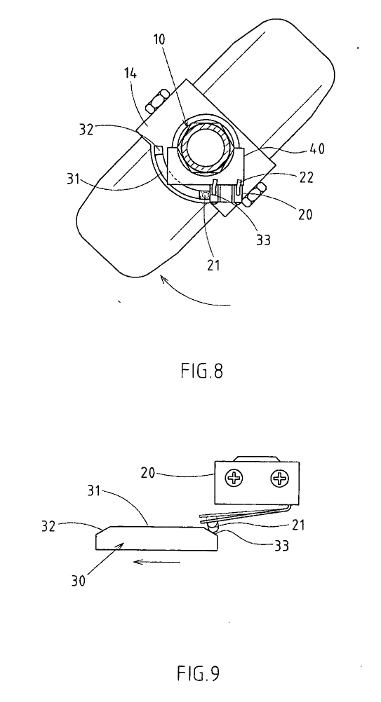

The new design is formed through the above structure. When it operates, as first illustrated in FIGS. 4 and 5, when the wheel carrier 14 of the head tube 10 is in leveled position, the feeler 21 of the sensor switch 20 can exactly touch against the above of the flat surface of the guiding base 30 and the circuit then appears to be close due to the pressure. And then as shown in FIGS. 6 and 7, when the wheel carrier 14 of the head tube 10 is at the angle of turning right, the feeler 21 of the sensor switch 20 will be aligned to the downward bevel 32 on the left side of the guiding base 30, and be activated due to the state of being flicked away, which will consequently activate the operation of the controller 13 of the two rear wheels 12. In the same way, as shown in FIGS. 8 and 9, when the wheel carrier 14 of the head tube 10 turns left, the feeler 21 of the sensor switch 20 will be aligned to the downward bevel on the right side of the guiding base 30, and be activated due to the state of being flicked away.

Therein, a seat plate of shaped form 4 can be formed on the front side of the fixed shaft sleeve 11 of the head tube 10, such that the sensor switch 2 can be locked and assembled at the site of the vertical panel 41 of the seat plate of shaped form 40.

Therein, the guiding base 30 can be designed to be an arch-shaped bumping block according to the circumgyrate route of the wheel carrier 14 of the head tube 10.

I claim:

1. A control mechanism for a steering differential device of an electric vehicle, said control mechanism comprising:
a touch sensor switch assembled on one side of the fixed shaft sleeve of the head tube on the electric vehicle, while the feeler is in the downward configuration state, wherein an electric circuit of the sensor switch is connected with the controller that controls the two rear wheels of the electric vehicle; and
a guiding base, which is set on the top of the wheel carrier lying at the bottom of the head tube and is exactly aligned to the place beneath the aforementioned sensor switch, wherein a middle part forms a flat surface, and its left and right ends form downward bevels, respectively, wherein, when the wheel carrier of the head tube is in leveled position, the feeler of the sensor switch can exactly touch against the above of the flat surface of the guiding base and the circuit then appears to be close due to the pressure, and wherein, when the wheel carrier of the head tube turns left or right, the feeler of the sensor switch will be aligned to the downward bevel of the guiding base, and be activated due to the state of being flicked away, which will consequently activate the operation of the controller.

2. The control mechanism of the steering differential device defined in claim 1, wherein said seat plate of shaped form can be formed on the front side of the fixed shaft sleeve of the head tube, such that the sensor switch can be locked and assembled at the site of the vertical panel of the seat plate of shaped form.

3. The control mechanism of the steering differential device defined in claim 1, wherein said guiding base is comprised of an arch-shaped bumping block according to the circumgyrate route of the wheel carrier of the head tube.
